(19) United States
(12) Patent Application Publication
(10) Pub. No.: US 2007/0288311 A1
(43) Pub. Date: Dec. 13, 2007

(54) Method and system for flexible incentive programs in sales organizations

(76) Inventor: Jeremy P. Underhill, Costa Mesa, CA (US)

Correspondence Address: Vic Lin;Myers Dawes Andras & Sherman, LLP, Suite 1150, 19900 MacArthur Blvd, Irvine, CA, 92612, US

(21) Appl. No.: 11/710,842

(22) Filed: Feb. 26, 2007

Related U.S. Application Data
(60) Provisional application No. 60/811,817, filed on Jun. 8, 2006.

(51) Int. Cl. G06Q 30/00

(52) U.S. Cl. 705/14

(57) ABSTRACT

A computer automated sales incentive program that allows companies of any size to easily create an account, invite participants to join the sales incentive program and then allow the companies to reward participants for sales.

### RELATED APPLICATION

This application claims priority from U.S. Provisional Patent Application Ser. No. 60/811,817, filed on Jun. 8, 2006, incorporated herein by reference.

### FIELD OF THE INVENTION

The present invention relates to methods and systems for incentive programs in sales organizations.

### BACKGROUND OF THE INVENTION

In competitive markets, companies cannot always expect that their products get picked up automatically by customers. To increase sales, many companies engage in advertising, high-power personal selling, large scale sales promotion, heavy price discounts and strong publicity and public relations, but do not enjoy expected customer patronage.

To increase customer patronage and sales, other companies use sales incentive programs to consciously push their products. However, existing sales incentive programs do not offer an all encompassing, computer automated (online) sales incentive program that is easily managed, and cost effective.

Companies employing existing sales incentive programs work with a client (participant) to increase sales by instigating sales programs. However, such sales incentive programs do not provide a simple and effective method of tracking sales and then supplying rewards to clients for those sales.

Further, such incentive programs do not provide an all in one, online, easy to create, easy to manage, sales incentive program that allows for the participants to choose the products those participants would be purchasing with the incentive dollars they earned.

Some sales incentive programs, for a fee, tailor an incentive program for a company's employees, tailor specific plans for company's employee's incentive programs, for a fee. Yet sales incentive programs utilize gift certificates without addressing the sales incentive issue at all.

As such, there is a need, for a computer automated sales incentive program method and system for use by a manufacturer of products sold through participating dealers, to provide incentives to those dealers to purchase the manufacturer's products over competitors. There is also a need for such a method and system to provide an easy way of tracking sales and then supplying rewards to participants for those sales.

### BRIEF SUMMARY OF THE INVENTION

In one embodiment, the present invention provides a computer automated sales incentive program that allows companies of any size to easily create an account, invite participants to join the sales incentive program and then allow the companies to reward participants for sales.

In a preferred embodiment the present invention provides a web implemented business method of suppliers providing sales incentives to participants, comprising the steps of: receiving information from a supplier during a supplier sign-up session at a terminal of a computer-controlled web based online sales incentive program over the Internet, said supplier information including a specified reward value for a participant following a sale of the supplier's goods/services by the participant; maintaining the supplier information in a supplier account in a database of the web based online sales incentive program; receiving information from a participant during a participant sign-up session at a terminal of the web based online sales incentive program, said information including selection of a supplier in the database; maintaining the participant in a participant account in said database; the web based online sales incentive program receiving indication of sale of goods/services of a selected supplier by the participant; the web based online sales incentive program providing said specified reward value from the selected supplier account to the participant account; the web based online sales incentive program receiving purchase information indicating an online purchase by a participant from an online shopping partner using accumulated reward values from that participant's account; and an operator of the web based online sales incentive program receiving a sales commission from the online shopping partner based on the purchase by the participant from the online shopping partner.

In another embodiment, the present invention provides a computer-controlled online sales incentive program system comprising: one or more client modules, each client module including a web browser operating on a client computer; a server module operating on a server computer connected to the client via the Internet; wherein the system allows suppliers to provides sales incentives to participants, by: the server module receiving information from a supplier during a supplier sign-up session at a web browser of a client module, said supplier information including a specified reward value for a participant following a sale of the supplier's goods/services by the participant; the server module maintaining the supplier information in a supplier account in a database; the server module receiving information from a participant during a participant sign-up session at a web browser of a client module, said information including selection of a supplier in the database; the server module maintaining the participant in a participant account in said database; the server module receiving indication of sale of goods/services of a selected supplier by the participant; and the server module providing said specified reward value from the selected supplier account to the participant account.

These and other features, aspects and advantages of the present invention will become understood with reference to the following description, appended claims and accompanying figures.

### BRIEF DESCRIPTION OF THE DRAWINGS

FIG. 1 shows an example flowchart of overall steps of an embodiment of a Web based sales incentive program, according to the present invention.

FIG. 2 shows an example of a more detailed flowchart of steps of an embodiment of a Web based sales incentive program implemented as a Web based software/hardware system, according to the present invention.

FIGS. 3A-J show example web pages generated by the Web based sales incentive program software/hardware system, according to an embodiment of the present invention.

FIG. 4 shows an example block diagram of an example network in which an embodiment of the present invention is implemented.

FIG. 5 shows a layer diagram of software modules that cooperate to provide a Web based sales incentive program system implementing steps of FIGS. 1-3, in an example network of FIG. 4, according to an embodiment of the present invention.

FIG. 6 shows a block diagram of an example architecture of a network in which a Web based sales incentive program system according to an embodiment of the present invention is implemented.

### DETAILED DESCRIPTION OF THE INVENTION

In one embodiment the present invention provides a computer automated sales incentive program that allows companies of any size to easily create an account, invite participants to join the sales incentive program and then allow the companies to reward participants for sales.

In a preferred embodiment of the present invention, such a computer automated sales incentive program is implemented as an online Internet Web based sales incentive program which provides simplified signing up for prospective suppliers and participants, and allows tracking of sales, etc.

According to an example of the Web based sales incentive program, the incentive rewards are actual funds that can be used by the participants (e.g., online) to purchase products from many online sales partners (e.g., online Web resellers and retailers). As such, participants that sign up with many companies offering the sales incentive program, can then at leisure purchase products from shopping partners with the collective reward funds received. This provides the participants with greater purchasing ability, as opposed to choosing products through a catalogue chosen by the companies offering rewards to their sales teams.

This method of reward therefore builds loyalty from the participants as they can visually see their account grow as they sell the enrolled companies products. The companies offering the rewards see greatly increased sales for a small percentage returned to the loyal participants.

The Web based sales incentive program further allows participating companies to offer a flexible incentive program without a large initial cash outlay or long lead-times to introduce a new program. Preferably, the Web based sales incentive program includes a management interface that reduces the time needed for a Supplier to administer a rewards program.

According to an example of the Web based sales incentive program, the participants (the rewards recipients) are offered a wide variety of reward and award choices including products offered by multiple partner sites, in addition to cash. Participants are much more likely to remember, and more fully use, an incentive program if the rewards are not simply cash.

The partners sign-up with the Web based sales incentive program, and an operator of Web based sales incentive program receives commissions on sales on the partner sites (using said rewards), allowing the operator to provide the Web based sales incentive program service at little or no cost to the suppliers. The partner sites include recognized and respected Web retailer sites, which most Internet users are already familiar with.

The Web based sales incentive program further allows the Suppliers to “tailor” the program to meet their needs. Commissions can be paid on the basis of “straight commission” structure (e.g., a flat percentage of each sale is paid to the participant's account), “commission with target” structure (e.g., no commission is paid until the participant reaches a sales target, based on sales count or total sales, at which point a flat percentage of all sales is paid to the participant), or a “progressive commission” structure (e.g., the percentage paid to the participant increases as the number or total value of sales increases). These structures can be completely controlled by the supplier—percentages, targets, etc. Individual salespeople can also be assigned their own commission rates, which differ from the rates paid to other salespeople.

The Web based sales incentive program also provides tools to the suppliers to manage their sales operation. Participants can be listed by e.g. sales volume or value, geographical region, or length of participation, etc. This allows suppliers to target their sales efforts more effectively. Suppliers can also use these tools to motivate their sales force by using custom emails—e.g. “Congratulations—you are the top seller in the Northwest region!”

An example implementation of the Web based sales incentive program is now described. As noted, Web based sales incentive program allows suppliers any size to: (1) easily create an account, (2) invite participants to join the sales incentive program and (3) reward participants for their sales. The Web based sales incentive program provides supplier sign-up, participant sign-up, tracking of sales, and funding of sales.

Accordingly, a supplier signs up with the operator of the Web based sales incentive program, and in the Web based sales incentive program specifies a funds value (reward) that will be sent to a potential participant following a sale (e.g., percentage per sale or sales target dollar) of the supplier's goods/services by a participant. A participant creates an account in the Web based sales incentive program and selects authorized suppliers to add to their account. The participant then sells a product of the supplier and the supplier sends rewards to the participant's account.

In turn the participant can spend the earned rewards at any number of online shopping partners of the participant's choice, via the Web based sales incentive program site. This process is managed online.

The Shopping Partners are the shopping online sites at which the Web based sales incentive program has established commission relationships. An operator of the Web based sales incentive program receives varying commission rates on purchases made by consumers (i.e., participants) accessing the Partners' sites through links on the Web based sales incentive program site provided by the operator of the Web based sales incentive program.

The suppliers are those companies using the Web based sales incentive program to “reward” their sales people (i.e., participants), completely separate from the Shopping Partners.

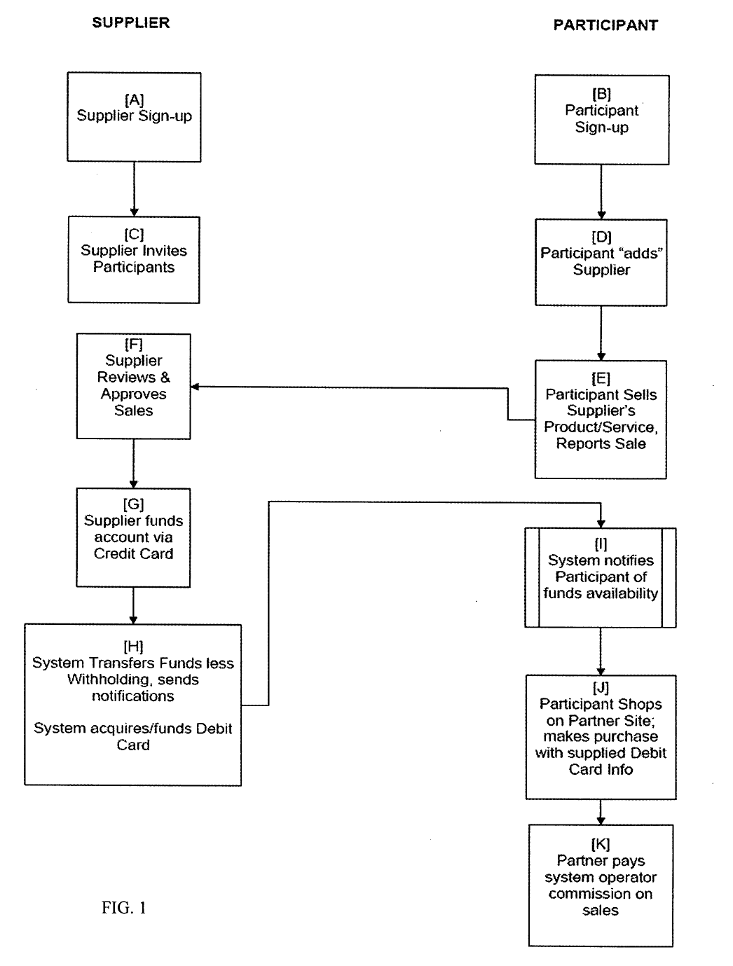

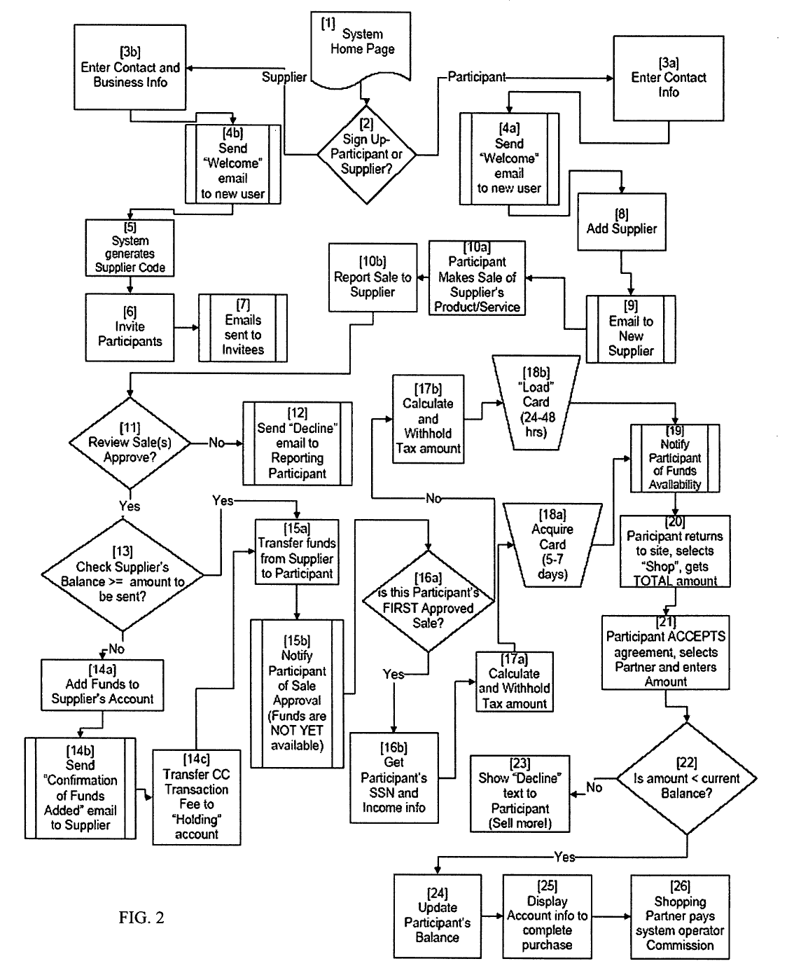

FIG. 1 shows an example flowchart of overall steps of an embodiment of a Web based sales incentive program, according to the present invention (steps A-K in FIG. 1 are further detailed in FIG. 2 described further below), wherein in FIG. 1:
Step A: Supplier sign-up (e.g., FIG. 2, steps 1-5).
Step B: Participant sign-up (e.g., FIG. 2, steps 1-4).
Step C: Supplier invites participants (e.g., FIG. 2, steps 6, 7).
Step D: Participant “adds” supplier (e.g., FIG. 2, steps 8, 9).
Step E: Participant sells supplier's product/service, reports sale (e.g., FIG. 2, steps 10a, b).
Step F: Supplier reviews and approves sales (e.g., FIG. 2, step 11).
Step G: Supplier funds account via credit card (e.g., FIG. 2, step 14).
Step H: System transfers funds less withholding, sends notifications (e.g., FIG. 2, steps 13-17); System acquires/funds debit card (e.g., FIG. 2, step 18a, b).
Step I: System notifies participant of funds availability (e.g., FIG. 2, step 19).
Step J: Participant shops on Partner site; makes purchase with supplied debit card information (e.g., FIG. 2, steps 20-25).
Step K: Partner pays system (Web based sales incentive program) operator commission on sales (e.g., FIG. 2, step 26).

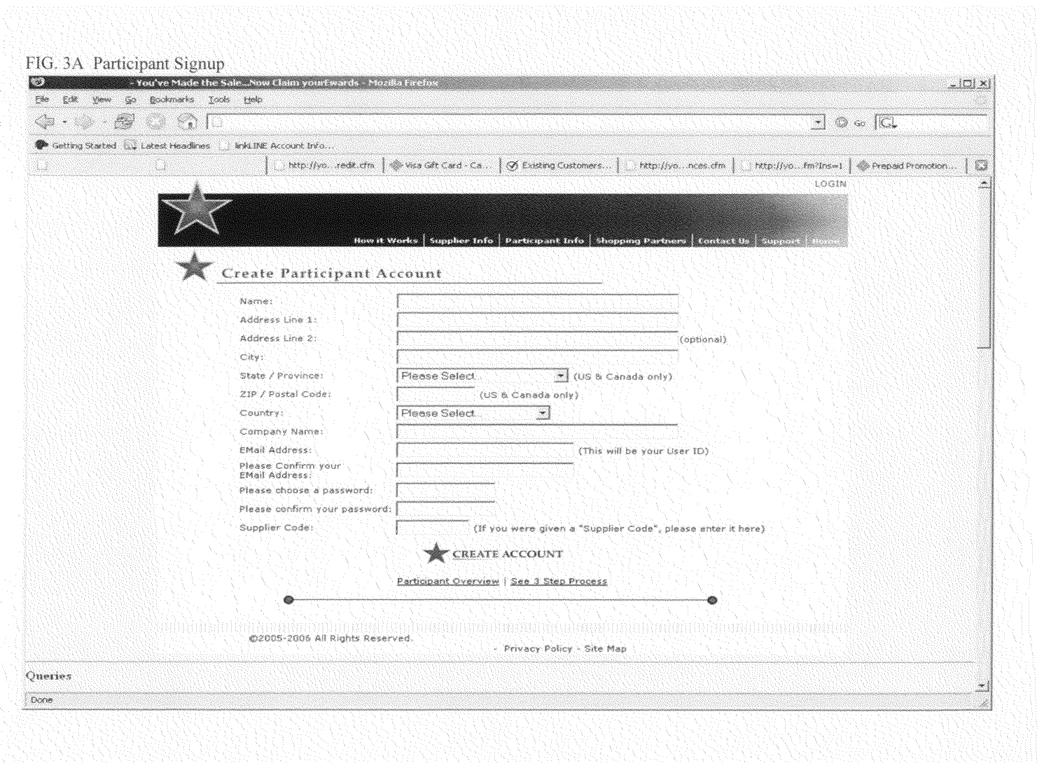

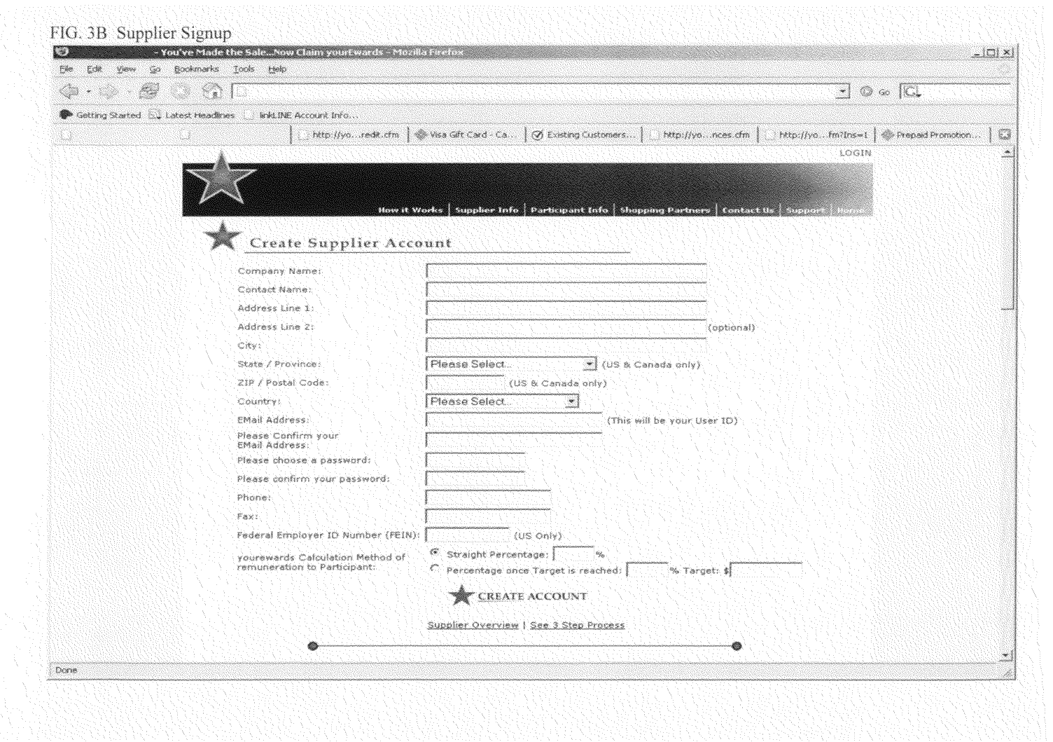

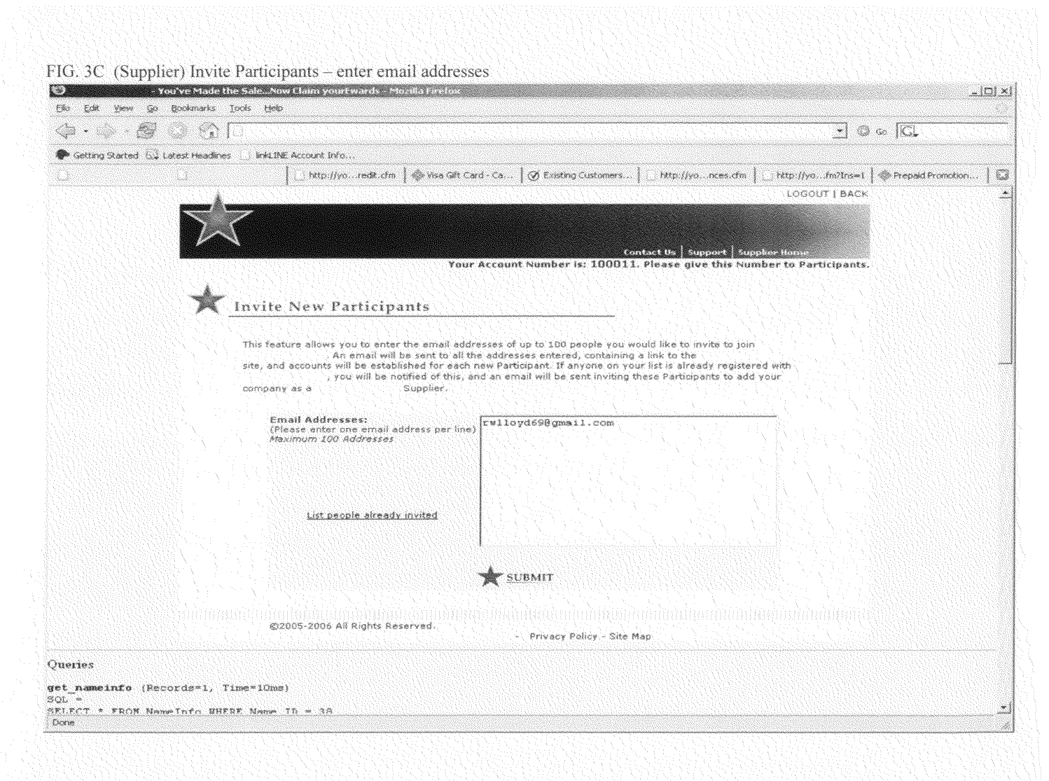

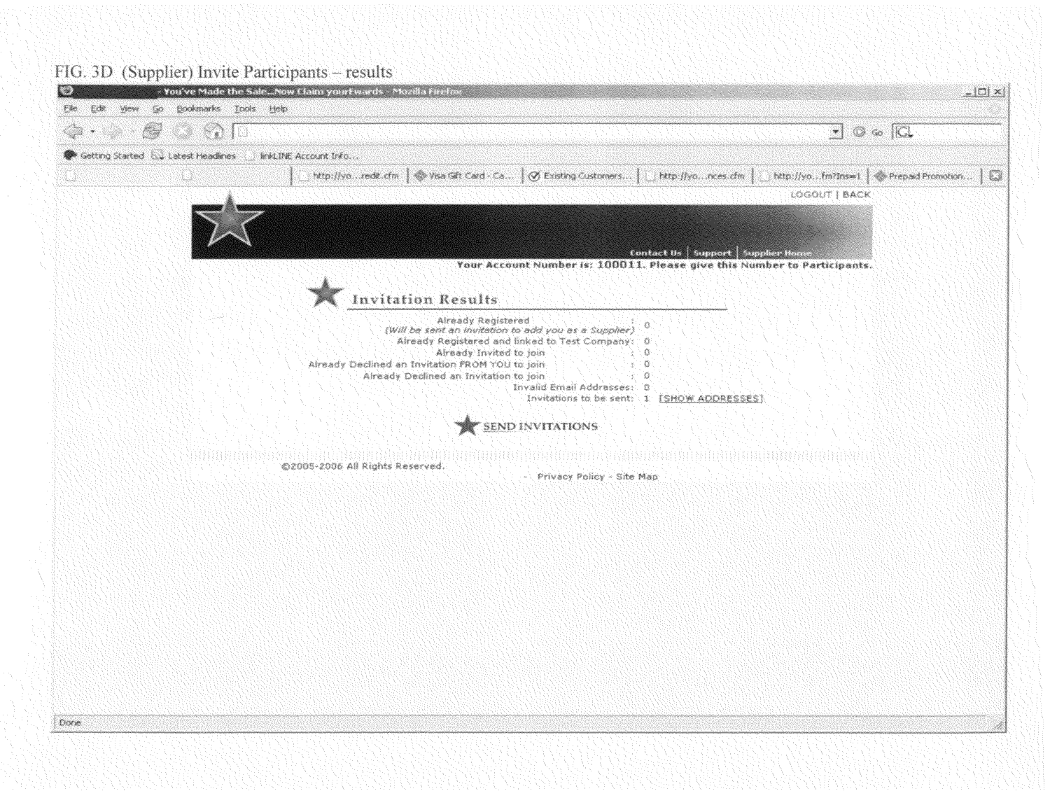

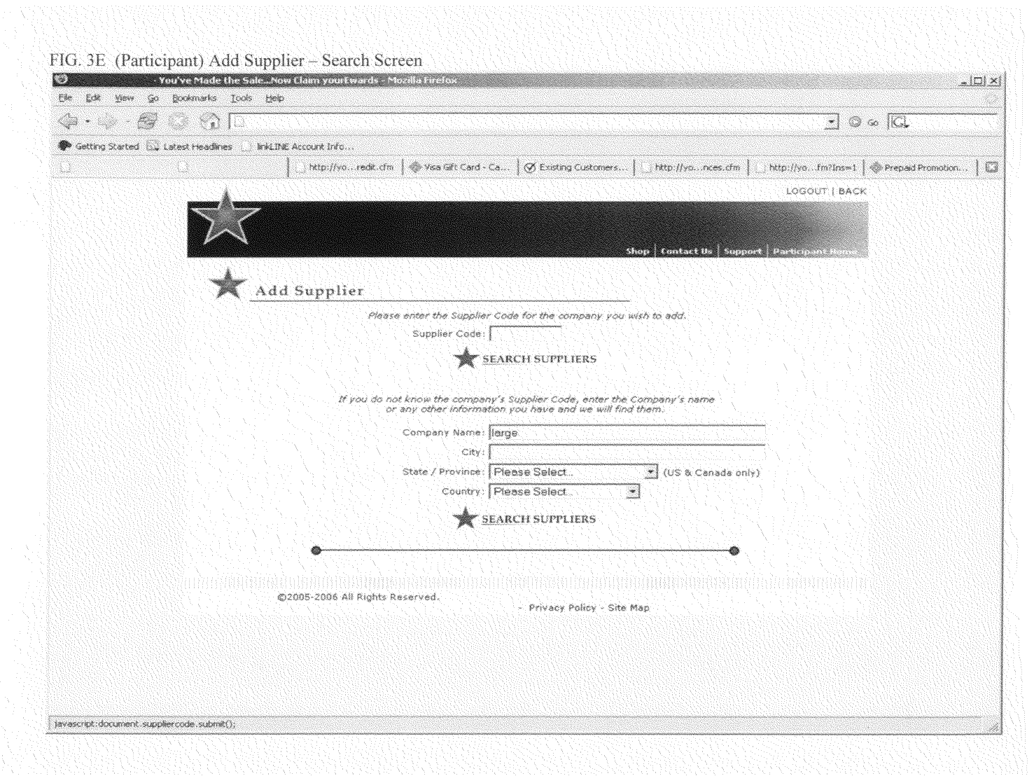

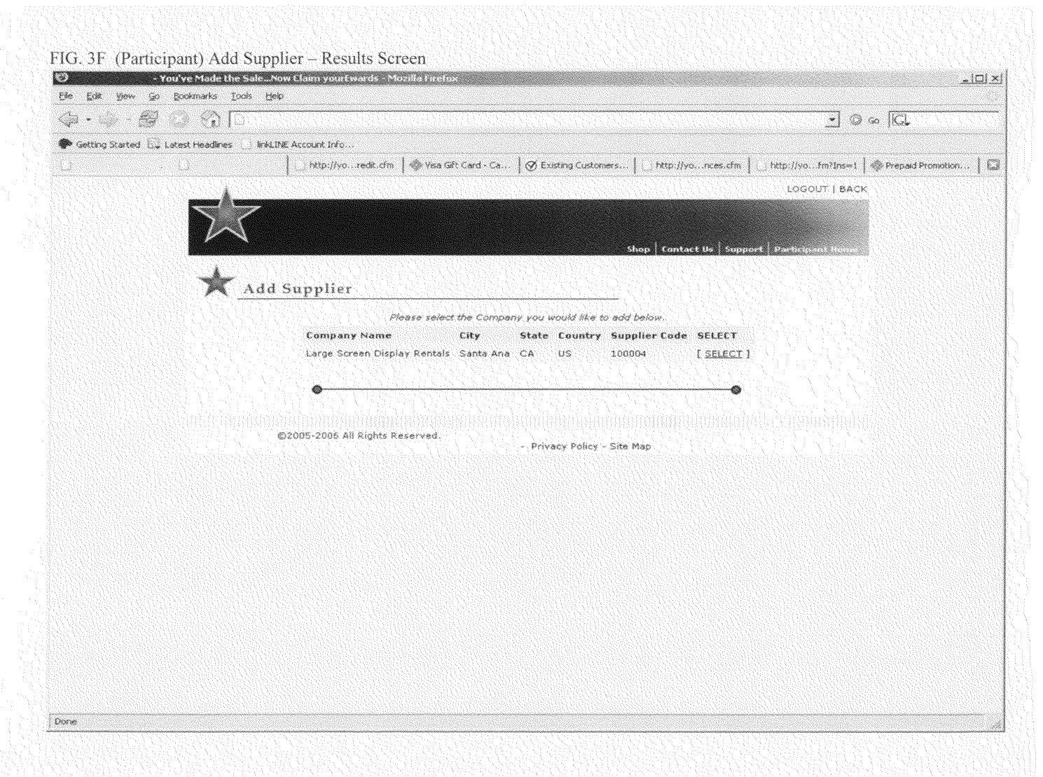

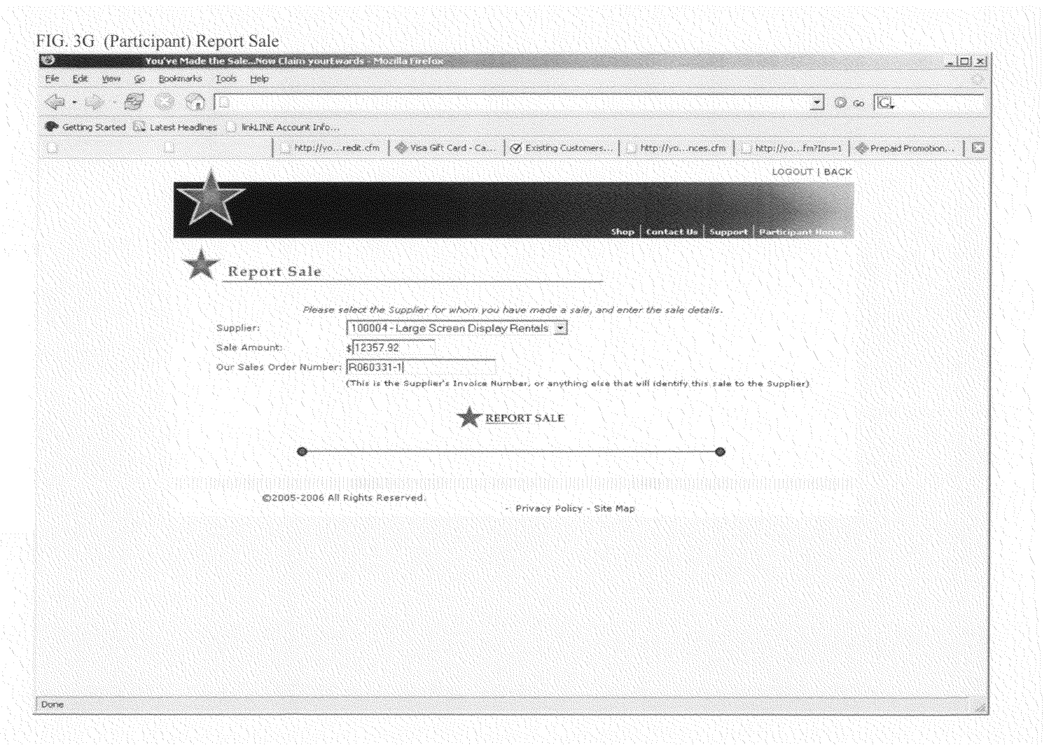

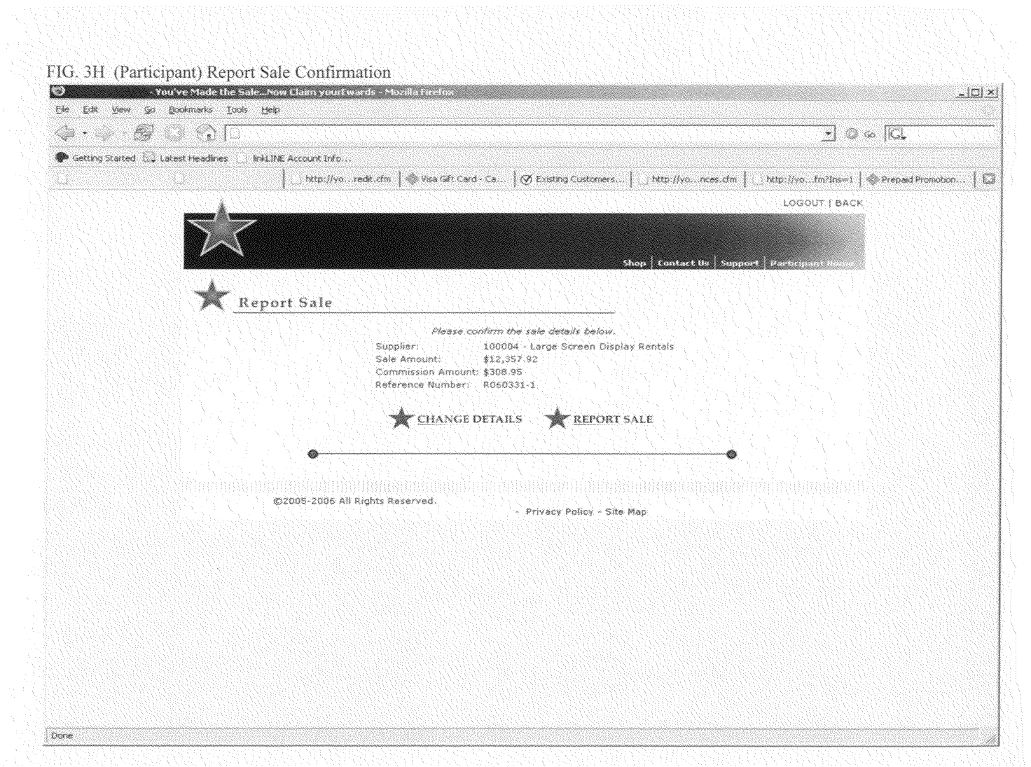

FIG. 2 shows an example of a more detailed flowchart of steps of an embodiment of a Web based sales incentive program implemented as a Web based software/hardware system, according to the present invention, including the steps of:
Step 1: A user (e.g., supplier, participant) goes to the web site of the Web based sales incentive program (i.e., Web based software system home page).
Step 2: On a web page of the system web site, user clicks “Create an Account” for either supplier or participant.
Step 3a: A participant user enters contact information (e.g., FIG. 3A shows example system web page for entering participant name, address, telephone numbers, email address, etc.)
Step 3b: A supplier user also enters business information (e.g., FIG. 3B shows example system web page for entering supplier business name and address, phone information (if different from contact info), etc.), and selects “commission” method (e.g., flat percentage, percentage with target, or progressive) and percentages (e.g., FIG. 3B).
Steps 4a and 4b: System sends user (supplier/participant) an automatic email welcoming them to the program.
Step 5: If user has signed up as a supplier, the system generates a unique, sequential “Supplier Code” to allow participants to easily “add” the supplier (see step 8 below).
Step 6: Supplier can send emails to potential participants inviting them to join the incentive program (e.g., FIG. 3C shows an example of a system web page for inviting new participants). Email addresses are entered and checked against existing data to prevent duplicate invitations (e.g., FIG. 3D shows example system web page for invitation results); Email addresses already entered as participants are invited to add this supplier to their account, as in step 8 below.
Step 7: Emails are sent automatically to invitees that have not already declined to join the incentive program, as part of an invitation process (e.g., when the incentive provider clicks on the “Send Invitations” link in FIG. 3D). Invitees have the opportunity to accept the invitation, decline any invitations from the sending supplier, or to decline any and all invitations from the incentive program system.
Step 8: Participant “adds a supplier”—the system “relates” the participant to this supplier, making the participant eligible to report sales to, and to earn rewards funds from, that Supplier (e.g., FIG. 3E shows example system web page for a participant that wants to add a supplier, to search suppliers, and FIG. 3F shows example system web page with search results).
Step 9: The system sends an email to the supplier with notification that the participant has “added” the supplier, in order to allow suppliers to welcome new participants.
Step 10a: Participant sells product/service of a supplier registered in the system.
Step 10b: The participant reports the sale to the supplier (e.g., FIG. 3G shows example system web page for participant reporting of sales, and FIG. 3H shows corresponding confirmation system web page).
Step 11: The supplier reviews the details of the participant's sale, and after receiving payment for the sale, “approves” the sale; alternatively, the supplier can decline the sale (e.g., FIG. 3I shows example system web page for supplier review of pending sales).
Step 12: If the sale is declined, the system sends an email to the participant notifying the participant of this, and refers the participant to the supplier with any questions, etc.
Step 13: If the supplier approves the sale, the system checks the supplier's current balance to determine if there are sufficient funds to cover the rewards funds to be sent to the participant (i.e., supplier's balance greater than or equal to (GTE) the amount to be sent).
Step 14a: If the supplier's balance is less than the rewards amount to be paid, the system allows the supplier to add funds to the account via credit card. The system adds the amount of the credit card fees to the amount required and then asks the supplier to confirm these fees.
Step 14b: The system sends an email to the supplier confirming this addition of funds.
Step 14c: The system transfers the amount of the transaction fee to a “holding” account.
Step 15a: Funds are transferred from the supplier's account to the appropriate participant's account who made the sale.
Step 15b: System sends an email to the participant confirming the approval of this sale with notification that the funds are not yet available for use.
Step 16a: System determines if the participant has not yet received rewards funds.
Step 16b: If so, the system requests the participant's Social Security Number (SSN) and income level information (e.g., FIG. 3J shows example system web page for participant's SSN identification and income information).
Step 17a: The system calculates the estimated income tax amount based on the income information provided by the participant and withholds that amount. These funds will be transferred to the taxing authorities on behalf of the participant at tax-year-end; or, if the amount awarded to the participant in that tax year is less than a minimum requirement, the withheld amount is released into the participant's account for use.
Step 17b: Similar to step 17a, differing only in that the participant in step 17b has already received rewards funds and the income and SSN information is already on file.
Step 18a: If the participant has not yet received rewards funds, a new debit card is acquired, funded and associated with the participant (e.g., by the system).
Step 18b: If the participant has already been awarded rewards funds, the debit card associated with that participant is funded to the new balance amount (e.g., by the system).
Step 19: Automated modules in the system monitor the on-line accounts of the bank issuing the debit cards to confirm that the transactions are complete; when they are, the participant is notified.
Step 20: The participant returns to the system web site and selects “shop”, selects a Partner, finds the item(s) the participant would like to purchase, and obtains a final total (including tax and shipping).
Step 21: The user (i.e., participant) must accept the system site's terms of use agreement to continue; the system prompts the participant to select the Shopping Partner and enter the total amount from step 20.
Step 22: The system checks the participant's current balance (i.e., determine if participant's account balance is less than (LT) the needed funds).
Step 23: If the participant does not have sufficient funds, the systems displays a “decline” message to the participant.
Step 24: If the funds are sufficient, the amount is debited from the participant's reward account.
Step 25: The system then displays the account information for the debit card associated with that participant.
Step 26: At end-of-period, the Shopping Partner pays the system operator commissions on all sales through the system web site for that period.

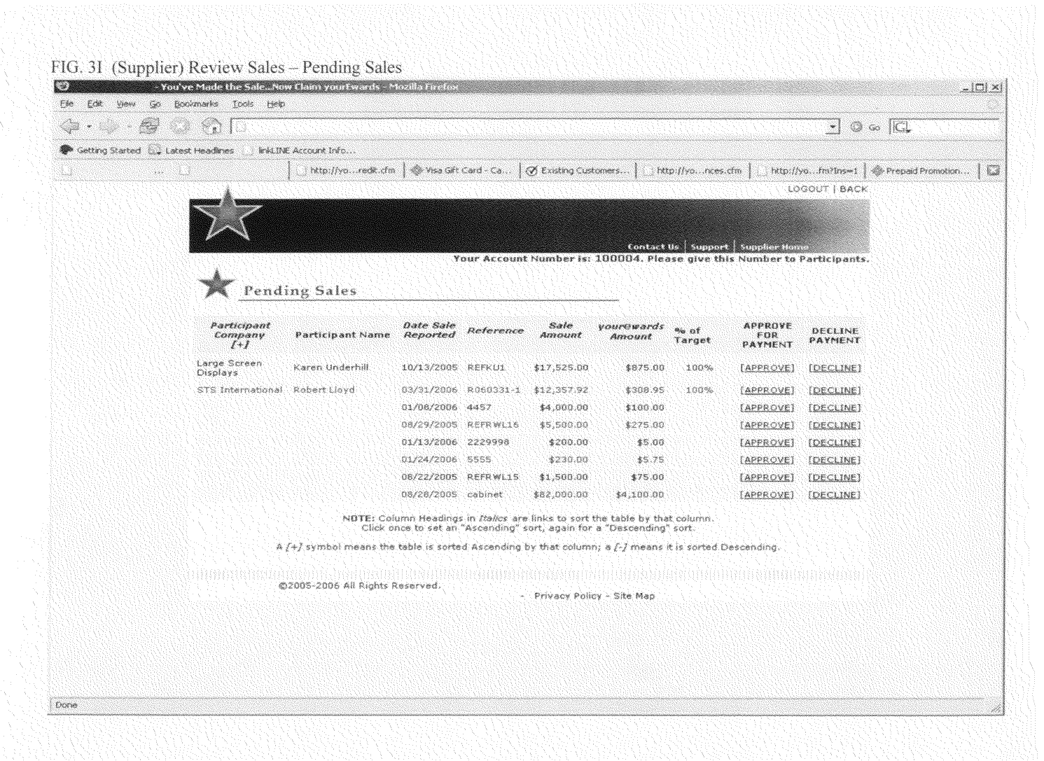

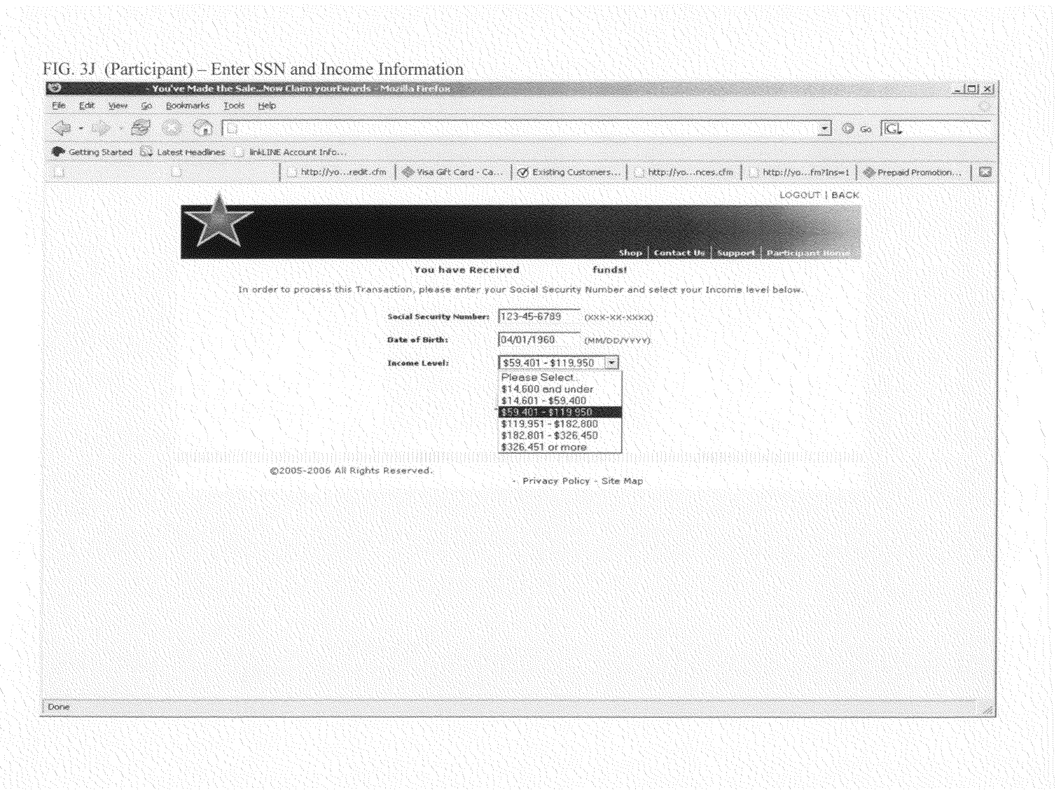

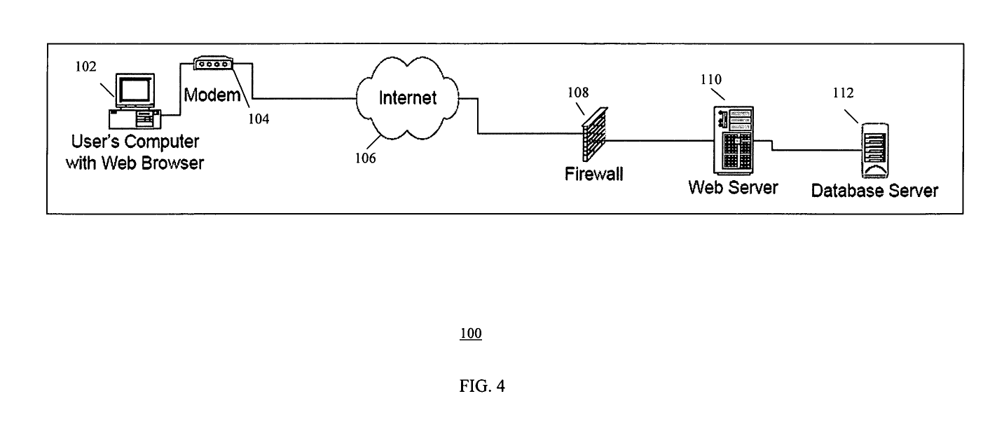

FIG. 4 shows an example block diagram of an example network 100 in which an embodiment of the present invention is implemented. The network 100 includes a Web Browser capable computer 102, a modem 104, communication paths through Internet 106, a firewall 108, a web server 110 and a database server 112. The term “web” herein refers to the World Wide Web on the Internet.

In this example a Web based sales incentive program implementing the example steps of FIGS. 1-3, comprises a Web based software/hardware system implemented on an Intel Pentium-4-based dual-processor Web Server 110 running Microsoft Internet Information Services (IIS) 6.0 web server software, and Macromedia ColdFusion MX 6.0 “middleware” and Oracle 8i database software on the database server 112. The server 110 is located in an operator's Web Host's Network Operations Center, protected by the firewall system 108 implemented by the Web Host. The data and much of the “business logic” (the implementation of business rules in FIGS. 1-3) resides on the database server 112, while IIS6 and ColdFusion provide the user interface to a user through the web browser on the computer 102. The web server 110 also uses Verisign's PayFlowPro software for handling credit card transactions. The web server 110 performs all communication with servers outside the yourewards network: authorizing credit cards through the Verisign servers, sending all the emails used by the system, and sending the web pages (which include data from the database server 112) to the client. The database server (112) communicates only with the web server (110), and functions as a data and logic repository.

Example software programming languages in which the system can be implemented include: Oracle PL/SQL (business logic layer), CFML (ColdFusion Markup Language—for interfacing the database to the Web Server), HTML (user interface), and JavaScript (user interface automation), etc.

The user utilizes the web browser on the computer 102 to access the Web based sales incentive program system web site implemented on servers 110 and 112 over the Internet 106. Any computer 102 with an Internet connection and a JavaScript-capable web browser can use the system web site, including nearly all PCs, Macs, and Linux machines, as well as “workstation-class” machines such as Sun, Silicon Graphics, etc. The user then interacts with the Web based sales incentive program system web site according to the above business method steps, according to an embodiment of the present invention.

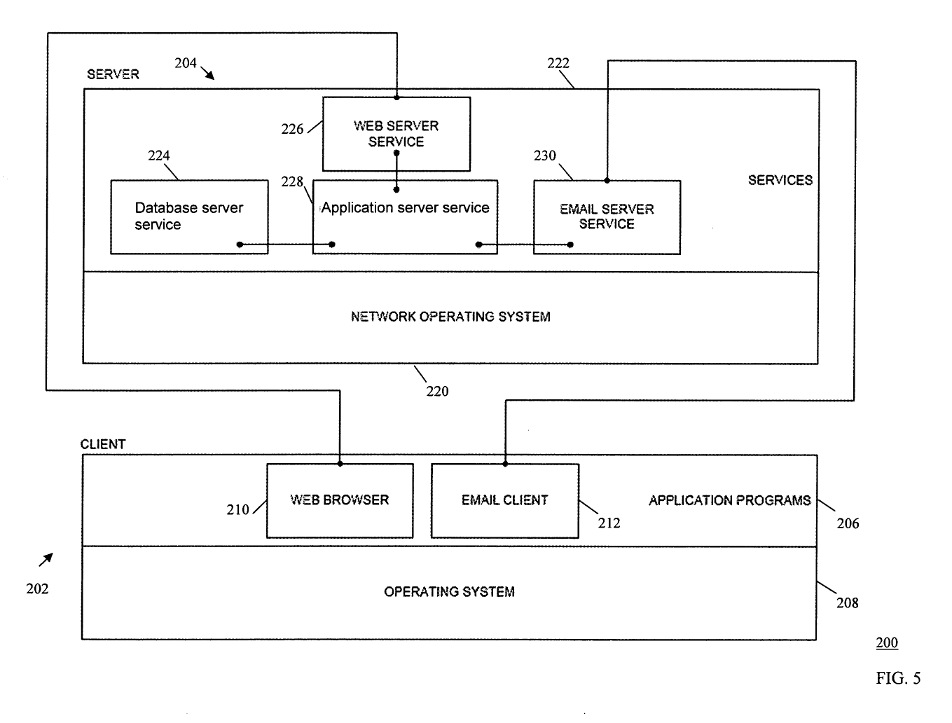

FIG. 5 shows a layer diagram of software modules that cooperate to provide a Web based sales incentive program system 200 implementing steps of FIGS. 1-3 described above, in an example network 100 of FIG. 4, according to an embodiment of the present invention. Referring to FIG. 5, the system 200 comprises a client module 202 and a server module 204. In this example, the client module 202 operates on the computer 104 in FIG. 4, and the server module 204 operates on the web server 110 in conjunction with the database server 112 (FIG. 4).

In the system 200, the client module 202 comprises application programs 206 including web browser 210 and e-mail client 212. The client module 202 may also include operating system 208. The server module 204 comprises service programs 222 including database server service (e.g., Oracle server service) 224, application server service (e.g., Coldfusion application server service) 228, e-mail server service 230 and web server service 226. The server module 204 may also include network operating system 220.

The email client 212 communicates with the email server service 230, and the web browser 210 communicates with the web server service 226. The database server service 224 responds to requests (typically from the application server service 228) for data stored in the database. The web server service 226 handles the communication between the server machine and the client machine. An example sequence of events on each request can include the steps of:
1. Web server 226 receives request from client for a web page in the application.
2. The web server 226 determines that the request is for a ColdFusion page (.cfm extension) and passes the request to the application server service 228.
3. The application server service 228 processes the page and the logic (“if this is true then do that”) and requests from the database server 224 any data needed to build the page.
4. The database server service 224 provides the requested information to the application server service 228.
5. The application server service 228 returns the page, with the data from the database server service included, to the web server service 226.
6. The web server service 226 sends the page back to the client.

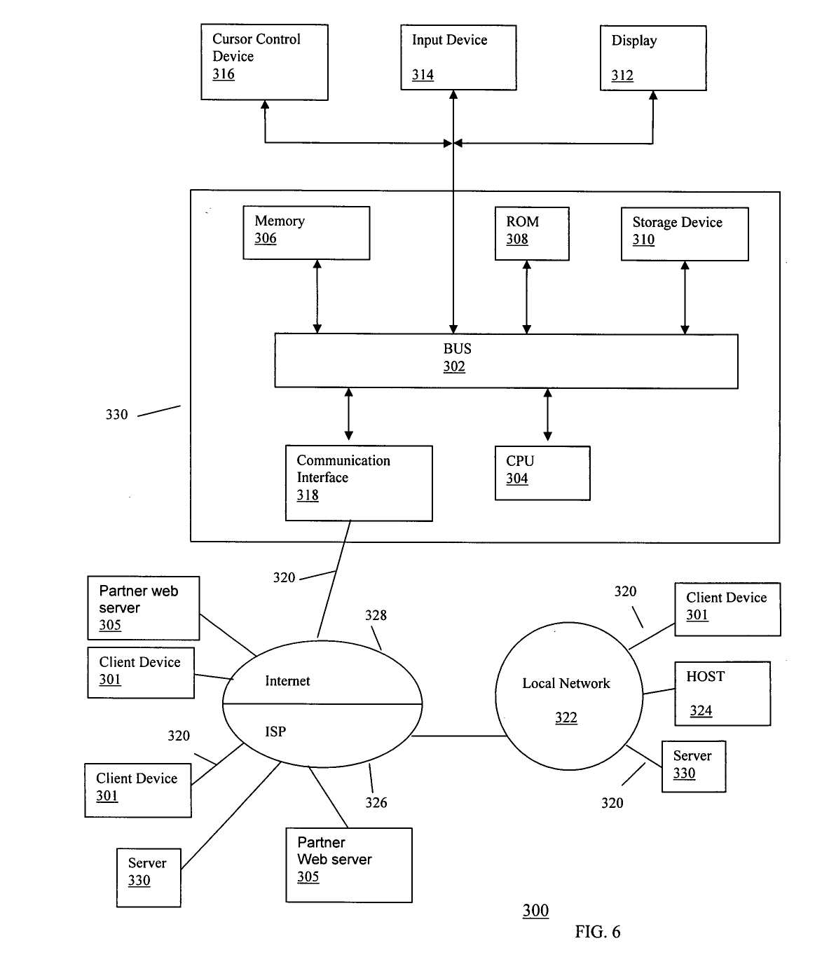

FIG. 6 shows a block diagram of an example architecture of a network 300 in which a Web based sales incentive program system according to an embodiment of the present invention is implemented. The network system 300 includes one or more e-mail capable client devices 301 (e.g., the computer 102 of FIG. 4 running the client module 202 of FIG. 5) connected to one or more e-mail capable server computing systems 330 (e.g., the server 110 of FIG. 4 running the server module 204 of FIG. 5).

A server 330 includes a bus 302 or other communication mechanism for communicating information, and a processor (CPU) 304 coupled with the bus 302 for processing information. The server 330 also includes a main memory 306, such as a random access memory (RAM) or other dynamic storage device, coupled to the bus 302 for storing information add instructions to be executed by the processor 304. The main memory 306 also may be used for storing temporary variables or other intermediate information during execution or instructions to be executed by the processor 304. The server computer system 330 further includes a read only memory (ROM) 308 or other static storage device coupled to the bus 302 for storing static information and instructions for the processor 304. A storage device 310, such as a magnetic disk or optical disk, is provided and coupled to the bus 302 for storing information and instructions. The bus 302 may contain, for example, thirty-two address lines for addressing video memory or main memory 306. The bus 302 can also include, for example, a 32-bit data bus for transferring data between and among the components, such as the CPU 304, the main memory 306, video memory and the storage 310. Alternatively, multiplex data/address lines may be used instead of separate data and address lines.

The main memory 306 can comprise dynamic random access memory (DRAM). And video memory (not shown) can comprise a dual-ported video random access memory. The server 330 may be coupled via the bus 302 to a display 312, such as a cathode ray tube (CRT), for displaying information to a computer user. An input device 314, including alphanumeric and other keys, is coupled to the bus 302 for communicating information and command selections to the processor 304. Another type of user input device comprises cursor control 316, such as a mouse, a trackball, or cursor direction keys for communicating direction information and command selections to the processor 304 and for controlling cursor movement on the display 312. This input device typically has two degrees of freedom in two axes, a first axis (e.g., x) and a second axis (e.g., y) that allows the device to specify positions in a plane.

According to one embodiment of the invention, the steps of the server module 204 are performed by a server 330 in response to the processor 304 executing one or more sequences of one or more instructions (based on FIGS. 1-3) contained in the main memory 306. Such instructions may be read into the main memory 306 from another computer-readable medium, such as the storage device 310. Execution of the sequences of instructions contained in the main memory 306 causes the processor 304 to perform the process steps described herein. One or more processors in a multi-processing arrangement may also be employed to execute the sequences of instructions contained in the main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participated in providing instructions to the processor 304 for execution. Such a medium may take many forms, including but not limited to, non-volatile media, volatile media, and transmission media. Non-volatile media includes, for example, optical or magnetic disks, such as the storage device 310. Volatile media includes dynamic memory, such as the main memory 306. Transmission media includes coaxial cables, copper wire and fiber optics, including the wires that comprise the bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 304 for execution. For example, the instructions may initially be carried on a magnetic disk of a remote computer. The remote computer can load the instructions into its dynamic memory and send the instructions over a telephone line using a modem. A modem local to the server 330 can receive the data on the telephone line and use an infrared transmitter to convert the data to an infrared signal. An infrared detector coupled to the bus 302 can receive the data carried in the infrared signal and place the data on the bus 302. The bus 302 carries the data to the main memory 306, from which the processor 304 retrieves and executes the instructions. The instructions received from the main memory 306 may optionally be stored on the storage device 310 either before or after execution by the processor 304.

The server 330 also includes a communication interface 318 coupled to the bus 302. The communication interface 318 provides a two-way data communication coupling to a network link 320 that is connected to the world wide packet data communication network now commonly referred to as the Internet 328. The Internet 328 uses electrical, electromagnetic or optical signals that carry digital data streams. The signals through the various networks and the signals on the network link 320 and through the communication interface 318, which carry the digital data to and from the server 330, are exemplary forms or carrier waves transporting the information.

In another embodiment of the server 330, interface 318 is connected to a local network 322 via a communication link 320. For example, the communication interface 318 may be an integrated services digital network (ISDN) card or a modern to provide a data communication connection to a corresponding type of telephone line, which can comprise part of the network link 320. As another example, the communication interface 318 may be a local area network (LAN) card to provide a data communication connection to a compatible LAN. Wireless links may also be implemented. In any such implementation, the communication interface 318 sends and receives electrical electromagnetic or optical signals that carry digital data streams representing various types of information.

The network link 320 typically provides data communication through one or more networks to other data devices. For example, the network link 320 may provide a connection through the local network 322 to a host computer 324 or to data equipment operated by an Internet Service Provider (ISP) 326. The ISP 326 in turn provides data communication services through the Internet 328. The local network 322 and the Internet 328 both use electrical, electromagnetic or optical signals that carry digital data streams. The signals through the various networks and the signals on the network link 320 and through the communication interface 318, which carry the digital data to and from the server 330, are exemplary forms of carrier waves transporting the information.

The server 330 can send/receive messages and data, including e-mail, program code, through the network, the network link 320 and the communication interface 318. Further, the communication interface 318 can comprise a USB/Tuner and the network link 320 may be an antenna or cable for connecting the server 330 to a cable provider, satellite provider or other terrestrial transmission system for receiving messages, data and program code from another source.

The example versions of the invention described herein can be implemented as logical operations in a distributed processing system such as the network system 300 including the servers 330 and clients 301. The logical operations of the present invention can be implemented as a sequence of steps executing in the server 330, and as interconnected machine modules within the network 300. The implementation is a matter of choice and can depend on performance of the network 300 implementing the invention. As such, the logical operations constituting said example versions of the invention are referred to for e.g. as operations, steps or modules.

Similar to a server 330 described above, an e-mail capable client device 301 can include a processor, memory, storage device, display, input device and communication interface (e.g., e-mail interface) for connecting the client device to the Internet 328, the ISP 326, or LAN 322, for communication with the severs 330. One or more of the clients are also Web browser capable.

The network system 300 further include one or more web servers 305 which implement the partner web sites for the participants to spend their reward funds as described above.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A computer implemented method of suppliers providing sales incentives to participants, comprising the steps of:
receiving information from a supplier during a supplier sign-up session at a terminal of a computer-controlled online sales incentive program in a computer network, said supplier information including a specified reward value for a participant following a sale of the supplier's goods/services by the participant;
maintaining the supplier information in a supplier account in a database of the computer-controlled online sales incentive program;
receiving information from a participant during a participant sign-up session at a terminal of the computer-controlled online sales incentive program, said information including selection of a supplier in the database;
maintaining the participant in a participant account in said database;
the computer-controlled online sales incentive program receiving indication of sale of goods/services of a selected supplier by the participant; and
the computer-controlled online sales incentive program providing said specified reward value from the selected supplier account to the participant account.

2. The method of claim 1 wherein the step of receiving information from a participant further includes the step of a supplier inviting a participant to select the supplier by sending an electronic notification to the participant utilizing an online notification module of the computer-controlled online sales incentive program.

3. The method of claim 2 wherein steps of receiving information from a participant further includes the steps of:
the participant receiving the notification from the supplier at a terminal of the computer-controlled online sales incentive program; and
the participant selecting the supplier at a terminal of the computer-controlled online sales incentive program, based on the notification from the supplier.

4. The method of claim 1 wherein the step of receiving indication of sale of goods/services further includes the steps of:
upon sales of good/services of a selected supplier by the participant, the participant sending notification to the computer-controlled online sales incentive program of the sale of goods/services of the selected supplier by the participant.

5. The method of claim 4 wherein the step of the participant sending notification further includes the step of:
upon selling good/services of a selected supplier by the participant, the participant sending a report of such sale to the selected supplier via a terminal of the computer-controlled online sales incentive program.

6. The method of claim 5 wherein the step of the computer-controlled online sales incentive program providing said specified reward value from the selected supplier account to the participant account, further includes the steps of:
the selected supplier receiving said sales report from the participant via the computer-controlled online sales incentive program;
the selected supplier reviewing the sales report, and if acceptable approving the sales; and
the computer-controlled online sales incentive program calculating the funds to transfer to the account of the participant based on the corresponding specified reward for the sale in the supplier account.

7. The method of claim 6 further comprising the steps of the computer-controlled online sales incentive program sending notification to the participant of the approval.

8. The method of claim 6 wherein the step of the selected supplier funding its account further includes the steps of:
the computer-controlled online sales incentive program determining if the selected supplier account balance is sufficient to transfer the specified reward funds to the participant;
if insufficient funds, the supplier adding sufficient funds to its account online; and
the computer-controlled online sales incentive program transferring calculated funds to the participant account.

9. The method of claim 1 further comprising the steps of:
the computer-controlled online sales incentive program receiving purchase information indicating an online purchase by a participant from an online shopping partner using accumulated reward values from that participant's account; and
an operator of the computer-controlled online sales incentive program receiving a sales commission from the online shopping partner based on the purchase by the participant from the online shopping partner.

10. The method of claim 1 further comprising the steps of:
the participant making a purchase from an online shopping partner utilizing a terminal of the computer-controlled online sales incentive program, using accumulated reward values from that participant's account for online payment to the shopping partner; and
the online shopping partner providing a sales commission to an operator of the computer-controlled online sales incentive program based on the purchase by the participant from the online shopping partner.

11. The method of claim 1 wherein the computer-controlled online sales incentive program comprises a Web based computer-controlled online sales incentive program.

12. The method of claim 1 wherein the computer-controlled online sales incentive program comprises a Web based computer-controlled online sales incentive program software system implemented on a web server connected to a web browser-capable client terminal via the Internet.

13. A computer-controlled online sales incentive program system comprising:
a server module operating on a server computer connected to one or more client modules via the Internet, each client module including a web browser operating on a client computer,
wherein the system allows suppliers to provides sales incentives to participants, by:
the server module receiving information from a supplier during a supplier sign-up session at a web browser of a client module, said supplier information including a specified reward value for a participant following a sale of the supplier's goods/services by the participant;
the server module maintaining the supplier information in a supplier account in a database;
the server module receiving information from a participant during a participant sign-up session at a web browser of a client module, said information including selection of a supplier in the database;
the server module maintaining the participant in a participant account in said database;
the server module receiving indication of sale of goods/services of a selected supplier by the participant; and
the server module providing said specified reward value from the selected supplier account to the participant account.

14. The system of claim 13 wherein the server module comprises:
a database server service module that stores said database;
an application server service module that allows suppliers to provides sales incentives to participants;
a notification server service module for sending notifications to participants and suppliers; and
a web server service module that communicates with a web browser.

15. The system of claim 14 wherein the application server service module further allows a supplier to invite a participant to select the supplier by sending an electronic notification via the notification server service module to the participant.

16. The system of claim 14 wherein:
the web browser provides the participant said supplier invitation notification from the notification server service module; and
under control of the application server service module the web browser allows the participant to select a supplier, based on the notification from the supplier.

17. The system of claim 14 wherein:
upon sales of good/services of a selected supplier by the participant, the participant sends notification to the application server service module via the notification server service module, of the sale of goods/services of the selected supplier by the participant.

18. The system of claim 17 wherein:
the notification server service module allows a participant to send a report of the sale to the selected supplier account via a client module; and
upon selling good/services of a selected supplier by the participant, the participant sending a report of such sale to the application server service module via the notification server service module, to provide to the supplier.

19. The system of claim 18 wherein:
the application server service module provides the sales report to the selected supplier via client module, for reviewing the sales report, and if acceptable approving the sales;
the application server service module calculates the funds to transfer to the account of the participant based on the corresponding specified reward for the sale in the supplier account; and
the application server service module provides said specified reward value from the selected supplier account to the participant account.

20. The system of claim 19 wherein the application server service module sends notification to the participant of the approval via the notification server service module.

21. The system of claim 20 wherein:
the application server service module determines if the selected supplier account balance is sufficient to transfer the specified reward funds to the participant;
if insufficient funds, the application server service module requires the supplier to add sufficient funds to its account online; and
the application server service module transfers calculated funds to the participant account.

22. The system of claim 13 wherein:
the server module allows a participant to make a purchase from an online shopping partner using accumulated reward values from that participant's account for online payment to the shopping partner, such that the online shopping partner provides a sales commission to an operator of the system based on the purchase by the participant from the online shopping partner.

23. A web implemented business method of suppliers providing sales incentives to participants, comprising the steps of:
receiving information from a supplier during a supplier sign-up session at a terminal of a computer-controlled web based online sales incentive program over the Internet, said supplier information including a specified reward value for a participant following a sale of the supplier's goods/services by the participant;
maintaining the supplier information in a supplier account in a database of the web based online sales incentive program;
receiving information from a participant during a participant sign-up session at a terminal of the web based online sales incentive program, said information including selection of a supplier in the database;
maintaining the participant in a participant account in said database;
the web based online sales incentive program receiving indication of sale of goods/services of a selected supplier by the participant;
the web based online sales incentive program providing said specified reward value from the selected supplier account to the participant account;
the web based online sales incentive program receiving purchase information indicating an online purchase by a participant from an online shopping partner using accumulated reward values from that participant's account; and
an operator of the web based online sales incentive program receiving a sales commission from the online shopping partner based on the purchase by the participant from the online shopping partner.

24. The method of claim 23 further comprising the steps of:
the participant making a purchase from an online shopping partner utilizing a terminal of the computer-controlled online sales incentive program, using accumulated reward values from that participant's account for online payment to the shopping partner; and
the online shopping partner providing a sales commission to an operator of the computer-controlled online sales incentive program based on the purchase by the participant from the online shopping partner.

25. The method of claim 23 wherein the web based online sales incentive program comprises a Web based online sales incentive program software system implemented on a web server connected to a web browser-capable client terminal via the Internet.
